(19) United States
(12) Patent Application Publication
(10) Pub. No.: US 2013/0337865 A1
(43) Pub. Date: Dec. 19, 2013

(54) COMMUNICATION DEVICE AND DATA EXCHANGE METHOD

(71) Applicant: Yasuhiro Aoyama, Tokyo (JP)

(72) Inventor: Yasuhiro Aoyama, Tokyo (JP)

(73) Assignees: NTT DOCOMO, INC., Tokyo (JP); Panasonic Mobile Communications Co., Ltd., Kanagawa (JP)

(21) Appl. No.: 14/002,278

(22) PCT Filed: Mar. 9, 2012
(86) PCT No.: PCT/JP2012/001643

§ 371 Date: Aug. 29, 2013

(30) Foreign Application Priority Data
Mar. 9, 2011 (JP) 2011-051613

(51) Int. Cl. H04W 88/06

(52) U.S. Cl. CPC H04W 88/06
USPC 455/552.1

(57) ABSTRACT

A communication device (100) can communicate through a plurality of communication systems consisting of communication (A) and communication (B). An external memory (108) stores control data to be used for controlling the communication by each communication system, with respect to each communication system. A built-in memory (106) can read/write the control data at a higher speed than the external memory (108). A CPU (105) provides instructions to read the control data of the communication system to be used from the external memory (108), and to store the data in the built-in memory (106), and also, upon switching the communication system to be used, the CPU provides instructions to exchange the control data of the communication system prior to the switching which is stored in the built-in memory (106), with the control data of the communication system after the switching which is stored in the external memory (108).

### TECHNICAL FIELD

The present invention relates to a communication apparatus and a data exchange method, and more particularly relates to a communication apparatus and a data exchange method for communication performed using a plurality of communication systems.

### BACKGROUND ART

Heretofore, implementation utilizing a built-in memory adjacent to the CPU has been commonly used as an approach to increase the communication speed in communication devices (e.g., Patent Literature 1). This approach can increase the communication speed by storing a specific communication control program or processing data desired to be processed at a higher speed in a built-in memory adjacent to the CPU and thus minimizing the time loss associated with memory access. This approach is a technique similar to instruction cache or data cache in that a memory adjacent to the CPU is utilized. This approach, however, is different from instruction cache or data cache in that the designer of the communication device specifies applications and in that addresses are statically assigned in general.

In addition, along with advancements in functionality of communication devices in recent years, communication devices each capable of supporting a plurality of communication systems such as wireless LAN, GSM, UMTS, and LTE have become common. In such communication devices with advanced functionality, the number of programs and the amount of data to be stored in a built-in memory increase as the number of supporting communication systems increases.

### CITATION LIST

### Patent Literature

PTL 1

Japanese Patent Application Laid-Open No. 2001-195261.

### SUMMARY OF INVENTION

### Technical Problem

In the related art devices, a built-in memory and a CPU are integrated in the same LSI. For this reason, the related art devices involve a problem in that the production costs of the LSI increase as the number of programs and the amount of data to be stored in the built-in memory increase. In addition, the capacity of a built-in memory increases with an increase in the number of programs and the amount of data to be stored in the built-in memory, which in turn leads to a problem in that the communication speed of the entire system decreases.

It is an object of the present invention to provide a communication apparatus and a data exchange method each capable of avoiding an increase in the production costs and a decrease in the communication speed of the entire system associated with advancements in functionality.

### Solution to Problem

A communication apparatus according to an aspect of the present invention is an apparatus capable of performing communication using a plurality of communication systems, the apparatus including: a first storage section that stores therein, for each of the communication systems, control data used for controlling communication performed using each of the communication systems; a second storage section that allows for reading and writing of the control data from and to the second storage section at a higher speed than the first storage section; a control section that reads from the first storage section, the control data of a communication system to be used, and stores the read control data in the second storage section, and that replaces, when switching between communication systems to be used is performed, the control data of the communication system used before the switching and stored in the second storage section with the control data of the communication system used after the switching and stored in the first storage section; and a communication section that performs communication using a communication system controllable by the control data stored in the second storage section.

A data exchange method according to an aspect of the present invention is a method in a communication apparatus capable of performing communication using a plurality of communication systems, the method including: reading control data of a communication system to be used from a first storage section that stores therein, for each of the communication systems, control data used for controlling communication performed using each of the communication systems; storing the control data read from the first storage section in a second storage section that allows for reading and writing of the control data from and to the second storage section at a higher speed than the first storage section; and replacing, when switching between communication systems to be used is performed, the control data of the communication system used before the switching and stored in the second storage section with the control data of the communication system used after the switching and stored in the first storage section.

### Advantageous Effects of Invention

According to the present invention, it is possible to avoid an increase in the production costs and a decrease in the communication speed of the entire system associated with advancements in functionality.

### BRIEF DESCRIPTION OF DRAWINGS

FIG. 1 is a block diagram illustrating a configuration of a communication apparatus according to an embodiment of the present invention;

FIG. 2 is a sequence diagram illustrating operation of the communication apparatus according to the embodiment of the present invention;

FIG. 3 is a diagram illustrating an operation environment of the communication apparatus according to the embodiment of the present invention;

FIG. 4 is a diagram illustrating a method of selectively using a built-in memory and an external memory when communication A is used in the embodiment of the present invention; and

FIG. 5 is a diagram illustrating a method of selectively using a built-in memory and an external memory when communication B is used in the embodiment of the present invention.

### DESCRIPTION OF EMBODIMENTS

Hereinafter, an embodiment of the present invention will be described in detail with reference to the accompanying drawings.

### Embodiment

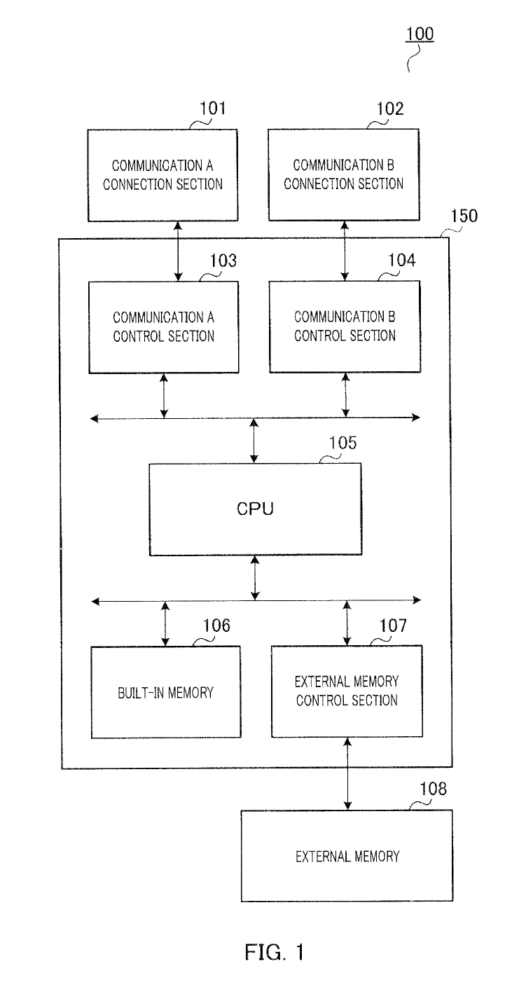

FIG. 1 is a block diagram illustrating a configuration of communication apparatus 100 according to an embodiment of the present invention. Communication apparatus 100 is a communication terminal apparatus such as a cellular phone. In FIG. 1, communication apparatus 100 supporting two kinds of communication systems (communication A and communication B) is described.

In FIG. 1, LSI 150 includes communication A control section 103, communication B control section 104, CPU 105, built-in memory 106, and external memory control section 107.

Communication A connection section 101 is connected to a communication counterpart and performs communication using the communication system of communication A in accordance with control performed by communication A control section 103.

Communication B connection section 102 is connected to a communication counterpart and performs communication using the communication system of communication B in accordance with control performed by communication B control section 104.

Communication A control section 103 controls communication A connection section 101 in accordance with an instruction from CPU 105. Specifically, communication A control section 103 uses data or a program for communication A stored in built-in memory 106 and thereby controls communication performed using communication A. The data or programs for communication A herein include shared functional data and shared functional programs shared between communication A and communication B, in addition to control data for communication A and a control program for communication A. The control data for communication A is used for controlling communication performed using communication A.

Communication B control section 104 controls communication B connection section 102 in accordance with an instruction from CPU 105. Specifically, communication B control section 104 uses data or a program for communication B stored in built-in memory 106 and thereby controls communication performed using communication B. The data or programs for communication B herein include shared functional data and shared functional programs shared between communication A and communication B, in addition to control data for communication B and a control program for communication B. The control data for communication B is used for controlling communication performed using communication B.

CPU 105 instructs communication A control section 103 to control communication A connection section 101. In addition, CPU 105 instructs communication B control section 104 to control communication B connection section 102. Moreover, CPU 105 instructs external memory control section 107 to store data or a program in external memory 108 or to read data or a program from external memory 108.

Specifically, CPU 105 instructs external memory control section 107 to read from external memory 108, data or a program for the communication system to he used. In addition, when switching between communication systems to be used is performed, CPU 105 instructs external memory control section 107 to read from built-in memory 106, data for the communication system used before the switching and to store the read data in external memory 108. Moreover, when switching between communication systems to he used is performed, CPU 105 instructs external memory control section 107 to read from external memory 108, data for the communication system to he used after the switching and to store the read data in built-in memory 106. More specifically, when switching between communication systems to be used is performed, CPU 105 performs control to replace data stored in built-in memory 106 and also to exchange data between built-in memory 106 and external memory 108.

Built-in memory 106 is a memory adjacent to CPU 105 and stores therein data or a program read from external memory 108 by external memory control section 107. Built-in memory 106 allows for reading and writing of data or a program from and to built-in memory 106 at a higher speed than external memory 108.

External memory control section 107 reads data or a program stored in external memory 108 from external memory 108 and stores the read data or program in built-in memory 106 in accordance with an instruction from CPU 105. In addition, external memory control section 107 stores data stored in built-in memory 106 in external memory 108 in accordance with an instruction from CPU 105. As a result, data stored in external memory 108 is updated.

External memory 108 is a memory connected to the outside of LSI 150 and stores therein data and programs used in communication A and communication B for each communication system.

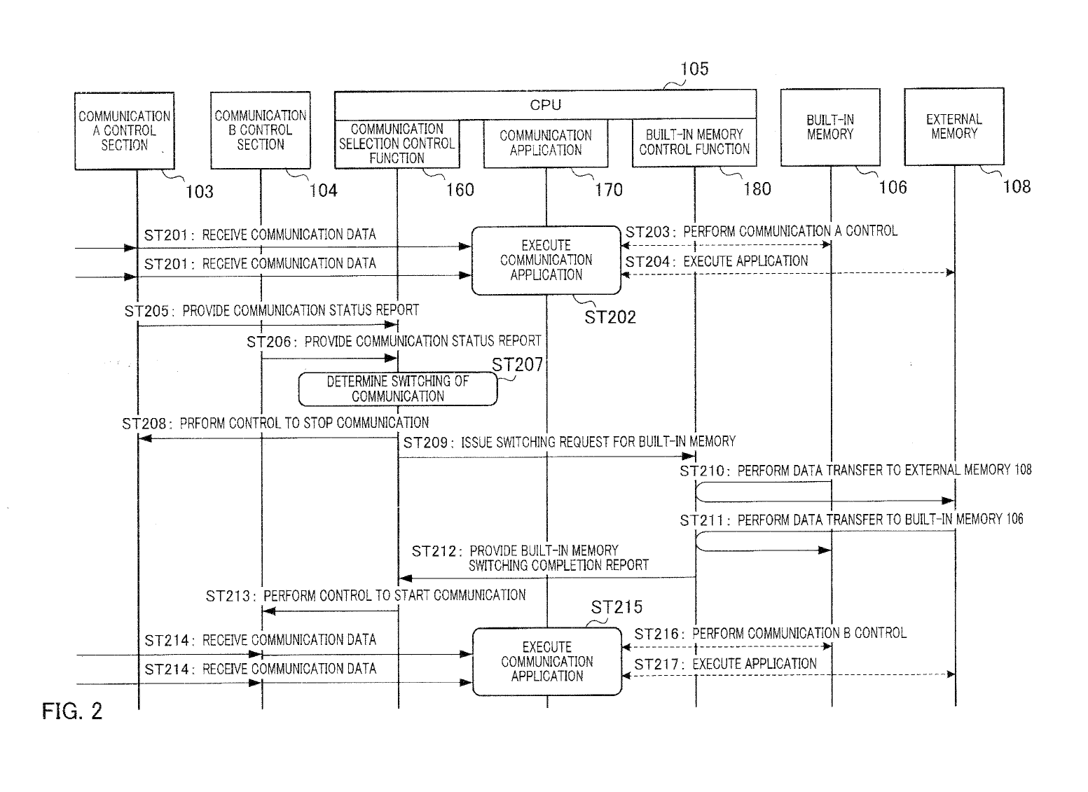

Next, a description will be given of operation of communication apparatus 100 with reference to FIG. 2. FIG. 2 is a sequence diagram illustrating the operation of communication apparatus 100.

CPU 105 includes communication selection control ft notion 160, communication application 170, and built-in memory control function 180, as a software function. Accordingly, the operation of CPU 105 will be described with reference to FIG. 2 with respect to each of the abovementioned functions. Note that, components identical to the components in FIG. 1 are assigned the same reference numerals in FIG. 2.

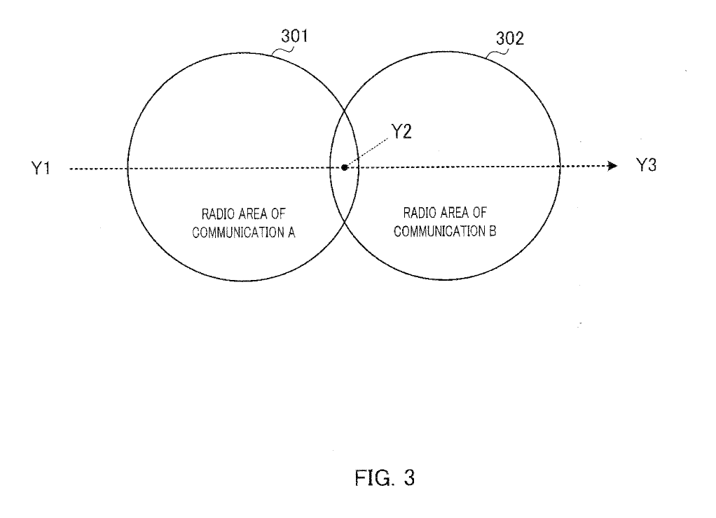

Mobile communication as illustrated in FIG. 3 is assumed in FIG. 2. FIG. 3 is a diagram illustrating an operation environment of communication apparatus 100. In FIG. 3, a broken line extending from Y1 to Y2 and a broken line extending from Y2 to Y3 indicate a moving direction of communication apparatus 100. Hereinafter, a description will be provided, assuming a situation where communication apparatus 100 executes a certain communication application while moving from radio area 301 of communication A to radio area 302 of communication B.

Referring to FIG. 2, communication application 170 of CPU 105 receives communication data and operates via communication A connection section 101 (illustration is omitted in FIG. 2) and communication A control section 103 during a period in which communication apparatus 100 is in radio area 301 of communication A illustrated in FIG. 3 (step ST 201).

Next, CPU 105 performs a communication control operation using built-in memory 106 (step ST 203) when executing a communication application in communication application 170 (step ST 202). In addition, CPU 105 performs an application operation riot related to communication control, using external memory 108 (step ST204) when executing a communication application in communication application 170 (step ST 202). Note that, a description will be :hereinafter provided regarding how built-in memory 106 and external memory 108 are selectively used when a communication application is executed.

Communication A control section 103 provides CPU 105 with a communication status report (step ST 205).

Communication B control section 104 provides CPU 105 with a communication status report (step ST 206). Upon receipt of these reports, CPU 105 finds out radio wave conditions or the like of communication A and communication B, using communication selection control function 160.

CPU 105 determines, when communication apparatus 100 continues moving and arrives at the position denoted by Y2 in FIG. 3, that communication apparatus 100 should switch from the communication path to another based on a variety of information collected by using communication selection control function 160 (step ST207).

Next, CPU 105 uses communication selection control function 160 and thereby controls communication A control section 103, which has been used up to this point, to stop communication (step ST208). As a result, communication A control section 103 blocks communication data.

Moreover, CPU 105 uses communication selection control function 160 and thereby notifies built-in memory control function 180 of a switching request for built-in memory 106 (step ST209).

Next, CPU 105 uses built-in memory control function 180 and thereby performs processing to write back control data stored in built-in memory 106 to external memory 108 (step ST210).

Next, CPU 105 performs rewrite processing for built-in memory 106 by data transfer using built-in memory control function 180 (step ST211). Note that, this rewrite processing will be described hereinafter.

In addition, upon completion of data transfer in step ST211, built-in memory control function 180 provides CPU 105 with a built-in memory switching completion report (step ST212). In addition, CPU 105 receives the built-in memory switching completion report, using communication selection control function 160.

Next, CPU 105 uses communication selection control function 160 and thereby controls communication B control section 104 to start communication (step ST213).

Next, communication B control section 104 receives communication data of communication B via communication B connection section 102 (illustration is omitted in FIG. 2) (step ST214). This operation is performed while communication apparatus 100 moves within radio area 302 of communication B in FIG. 3.

In addition, CPU 105 uses communication application 170 and thereby executes a communication application while receiving communication data (step ST215). Meanwhile, CPU 105 executes a communication control operation using built-in memory 106 (step ST216). In addition, CPU 105 uses external memory 108 and thereby executes an application operation not related to communication control (step ST217).

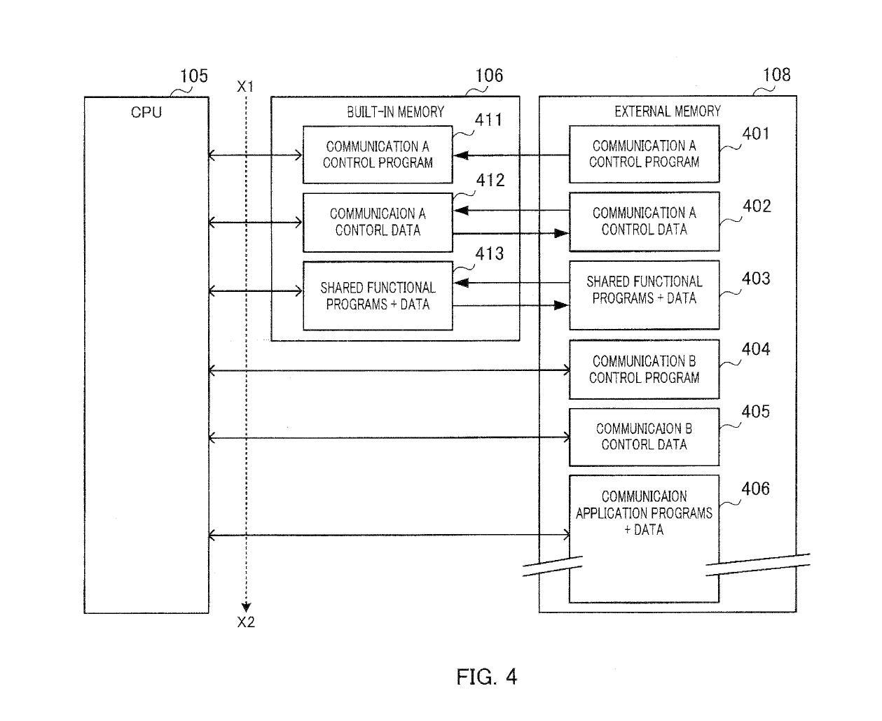

Next, a description will he provided with reference to FIG. 4 regarding how built-in memory 106 and external memory 108 are selectively used when communication A is used. FIG. 4 is a diagram for describing a method of selectively using built-in memory 106 and external memory 108 when communication A is used. Note that, FIG. 4 illustrates processing in steps ST202 to ST204 in FIG. 2.

FIG. 4 illustrates CPU 105, built-in memory 106, and external memory 108, aligned horizontally, and conceptually illustrates an address map defined by CPU 105, Moreover, in FIG. 4, a broken line extending from X1 to X2 indicates the address advancing direction of the address map.

External memory 108 stores therein in the order illustrated in FIG. 4, communication A control program 401, communication A control data 402, shared functional programs and data 403, communication B control program 404, communication B control data 405, communication application programs and data 406.

Furthermore, the program regions of external memory 108 are regions where CPU 105 performs only reading. Meanwhile, the data regions of external memory 108 are regions where CPU 105 performs reading and rewriting. Moreover, the shared functional region of external memory 108 is a region for storing programs and data shared between a period under the control of communication A and a period under the control of communication B.

in executing a communication application in step ST202 in FIG. 2, communication A control program 401, communication A control data 402, and shared functional programs and data 403, which are stored in external memory 108, are not used. Instead, communication A control program 411, communication A control data 412, and shared functional programs and data 413, which are stored in built-in memory 106 after being read from external memory 108, are used. The reason behind this is to achieve an increase in the communication speed of communication A by using built-in memory 106 during communication performed using communication A.

Moreover, during data transfer to external memory 108 in step ST210 of FIG. 2, data is written back to external memory 108 from built-in memory 106. During this processing, the direction in which data is written back is the direction from communication A control data 412 to communication A control data 402, and the direction from shared functional programs and data 413 to shared functional programs and data 403 in FIG. 4. During this data transfer, no program is written back.

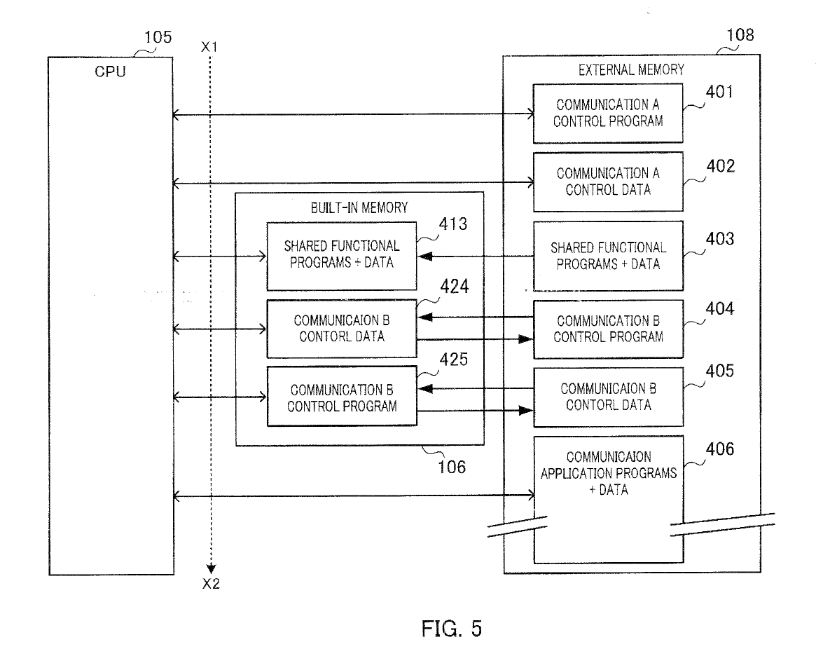

Next, a description will be provided with reference to FIG. 5 regarding how built-in memory 106 and external memory 108 are selectively used when communication B is used. FIG. 5 is a diagram for describing a method of selectively using built-in memory 106 and external memory 108 when communication B is used. Note that, a variety of programs and data stored in external memory 108 are identical with those illustrated in FIG. 4, so that the description thereof will be omitted hereunder.

FIG. 5 conceptually illustrates an address map defined by CPU 105 as in the case of FIG. 4. The broken line extending from X1 to X2 indicates the address advancing direction of the address map.

FIG. 5 is different from FIG. 4 in the position of built-in memory 106 on the address map. Specifically, built-in memory 106 stores therein shared functional programs and data 413, communication B control data 424, and communication B control program 425 in order to support communication B in FIG. 5. These programs and data are obtained and stored in built-in memory 106 by reading shared functional programs and data 403, communication B control program 404, and communication B control data 405, which are stored in external memory 108. Storing the programs and data in built-in memory 106 is performed by data transfer to built-in memory 106 in step ST211. of FIG. 2.

It should he noted that, since shared functional programs and data 413 are sharable between communication A and communication B, shared functional programs and data 413 remain stored in built-in memory 106 and not replaced, however, when the communication system to he used is switched from communication A to communication B.

In addition, when a communication application is executed in step ST215 in FIG. 2, shared functional programs and data 403, communication B control program 404, and communication B control data 405, which are stored in external memory 108, are not used.

Instead, shared functional programs and data 413, communication B control data 424, and communication B control program 425, which are stored in built-in. memory 106, are used. The reason behind this is also to achieve an increase in the communication speed of communication B by using built-in memory 106 during communication performed using communication B as in the case of communication performed using communication A.

As is apparent from a comparison between FIG. 4 and FIG. 5, the regions of built-in memory 106 for storing control data and a control program for communication A are different from the regions of built-in memory 106 for storing control data and a control program for communication B.

Accordingly, in this embodiment, a program and data to be stored in the built-in memory are replaced in accordance with switching between communication systems. As a result, according to this embodiment, it is possible to avoid an increase in the production costs and a decrease in the communication speed of the entire system associated with advancements in functionality, and also to achieve a decrease in the CPU load.

Note that, although switching between two kinds of communication systems, which are communication A and communication B, is performed in this embodiment, the present invention is by no means limited to this configuration, and switching between three or more kinds of optional communication systems can be performed.

Moreover, one each of a CPU, a built-in memory, and an external memory is provided in the present embodiment. However, the present invention is by no means limited to this configuration, and any number of CPUs, built-in memories, and external memories can be provided.

In addition, an address assignment method other than the one described in this embodiment can he used for the built-in memory and external memory.

The disclosure of the specification, the drawing, and the abstract of Japanese Patent Application No. 2011-51613, filed on Mar. 9, 2011, is incorporated herein by reference in its entirety.

### INDUSTRIAL APPLICABILITY

The communication apparatus and data exchange method according to the present invention are suitable for performing communication using a plurality of communication systems in particular.

### REFERENCE SIGNS LIST

100 Communication Apparatus
101 Communication A connection section
102 Communication B connection section
103 Communication A control section
104 Communication B control section
105 CPU
106 Built-in memory
107 External memory control section
108 External memory

1. A communication apparatus capable of performing communication using a plurality of communication systems, the apparatus comprising:
a first storage section that stores therein, for each of the communication systems, control data used for controlling communication performed using each of the communication systems;
a second storage section that allows for reading and writing of the control data from and to the second storage section at a higher speed than the first storage section;
a control section that reads from the first storage section, the control data of a communication system to be used, and stores the read control data in the second storage section, and that replaces, when switching between communication systems to be used is performed, the control data of the communication system used before the switching and stored in the second storage section with the control data of the communication system used after the switching and stored in the first storage section; and
a communication section that performs communication using a communication system controllable by the control data stored in the second storage section.

2. The communication apparatus according to claim 1, wherein;
the first storage section stores therein, in addition to the control data, shared functional data to be shared among a plurality of communication systems; and
the control section reads from the first storage section, the shared functional data of a communication system to be used and stores the read shared functional data in the second storage section, and when switching between communication systems to he used is performed, the control section does not replace the shared functional data to be shared between the communication system used before the switching and the communication system used after the switching.

3. The communication apparatus according to claim 1, wherein, when switching between communication systems to be used is performed, the control section updates the control data of the communication system used before the switching and stored in the first storage section to be the control data of the communication system used before the switching and stored in the second storage section.

4. The communication apparatus according to claim 1, wherein the control section stores the control data of the communication system used after the switching in a storage region of the second storage section, the storage region being different from a storage region of the second storage section where the control data of the communication system used before the switching is stored.

5. A data exchange method in a communication apparatus capable of performing communication using a plurality of communication systems, the method comprising:
reading control data of a communication system to be used from a first storage section that stores therein, for each of the communication systems, control data used for controlling communication performed using each of the communication systems;
storing the control data read from the first storage section in a second storage section that allows for reading and writing of the control data from and to the second storage section at a higher speed than the first storage section; and
replacing, when switching between communication systems to be used is performed, the control data of the communication system used before the switching and stored in the second storage section with the control data of the communication system used after the switching and stored in the first storage section.
